(19) United States
(12) Patent Application Publication
(10) Pub. No.: US 2010/0099532 A1
(43) Pub. Date: Apr. 22, 2010

(54) Hybrid drive method and apparatus

(76) Inventor: Wilhelm A. Cashen, Camarillo, CA (US)

Correspondence Address: CLIFFORD H. KRAFT, 320 ROBIN HILL DR., NAPERVILLE, IL, 60540, US

(21) Appl. No.: 12/288,444

(22) Filed: Oct. 20, 2008

(51) Int. Cl. B60W 10/10; B60K 6/36; B60W 20/00

(52) U.S. Cl. 475/5; 180/65.265; 180/65.8

(57) ABSTRACT

A method and apparatus that limits the amount of rotating mass in a hybrid drive system that can use an internal combustion engine driving a motor/generator through an electronically controllable clutch. The engine can thus turn the generator to charge a battery. A second clutch can connect this motor/generator to a differential to directly drive the wheels, or to receive braking energy from the wheels. A second electric motor/generator can be coupled directly into the differential so that it can always drive the wheels or recapture braking energy. The two clutch system of the present invention allows several modes: 1) The internal combustion motor drives the generator charging the battery, while the other motor drives the wheels. 2) Both motors drive the wheels. The internal combustion engine can be running or not running. 3) One motor recaptures energy from braking. 4) Both motors recapture energy from braking. 5) The first motor is used to start the engine. In one embodiment of the invention, multiple tandem electric motors can be clutched in and out as needed.

### BACKGROUND

1. Field of the Invention

The present invention relates generally to the field of hybrid vehicles or craft and more particularly to a method and apparatus for a hybrid vehicle or craft drive using an internal combustion engine and two electric motor/generators.

2. Description of the Prior Art

It is known in the art of hybrid vehicles to use an internal combustion engine and two motors or motor/generators. Kitada et al. in U.S. Pat. No. 6,817,432 teach a hybrid vehicle equipped with an engine and first and second rotary machines. Iwanaka et al. teach a hybrid drive apparatus with planetary gears that has an engine and two rotary electric machines. It is also known in the art to provide what is loosely called a serial system where an engine drives a generator that charges a battery, and the battery drives an electric motor that transmits power to the wheels. Finally, it is known in the art to recapture energy during braking by using an electric drive motor as a generator to charge the battery during braking.

Most of the prior art vehicle systems use transmissions with planetary gears or other gear arrangements to couple motors to wheels. Transmissions are expensive, complex and inefficient causing an overall power loss from heat caused by friction. It would be advantageous to have a hybrid vehicle drive system that did not need a transmission, could use an internal combustion engine to charge a battery through a motor/generator that could also recapture braking energy. Also, hybrid vehicles that use large electric motors have the problem of having to rotate a large mass with its associated friction when such a large motor may not be needed once the vehicle or craft has reached an operating speed. It would be advantageous to avoid a single large motor and rather use several smaller motors.

### SUMMARY OF THE INVENTION

The present invention relates to a method and apparatus for driving a hybrid vehicle or craft that can use an internal combustion engine to drive at least one motor/generator through an electronically controllable clutch to run in generator mode and charge a battery. A second clutch can connect this motor/generator to a differential to directly drive the wheels, or to receive braking energy from the wheels. A direct connection can be made to a propeller or other propulsion device on a craft such as a boat. A second electric motor/generator can be coupled directly into the differential or to an output drive shaft so that it can always drive the wheels or other load and optionally recapture braking energy. The two clutch system of the present invention allows several modes: 1) The internal combustion motor drives the generator charging the battery, while the other motor drives the vehicle or craft. 2) Both motors drive the vehicle with the internal combustion engine either running or not running. 3) One motor recaptures energy from braking. 4) Both motors recapture energy from braking. 5) The first motor is used to start the engine. In an alternate embodiment, one motor can drive front wheels while the other motor drives rear wheels. The present invention is a method for limiting the amount of rotating mass in a system and hence, the amount of associated frictional and other losses.

### DESCRIPTION OF THE FIGURES

Attention is now directed toward several illustrations of various features of the present invention.

FIG. 1 is a block diagram of an embodiment of the present invention.

FIG. 2A shows the clutching and coupling between the internal combustion engine, the two motor/generators and the differential.

FIG. 2B shows the use of an optional third clutch.

FIG. 3 shows the embodiment of FIG. 1 with a converter.

FIG. 4 shows an alternate embodiment where the second motor/generator drives a different pair of wheels.

FIG. 5 shows the motors coupled to a drive shaft rather than a differential.

FIG. 6 shows the embodiment of FIG. 1 with a power take-off shaft.

FIG. 7 shows multiple tandem motors that can be clutched in as needed for more power.

Several drawings and illustrations have been presented to aid in understanding the present invention. The scope of the present invention is not limited to what is shown in the figures.

### DESCRIPTION OF THE INVENTION

The present invention relates to a hybrid drive method and apparatus that limits the amount of rotating mass in a drive system by using several smaller motors rather than a single large motor and that runs with no transmission or planetary gears. The preferred embodiment uses an internal combustion engine, at least two motor/generators, two or more clutches and a differential or directly coupled output shaft. While two is the preferred number of motor/generators, any number may be used and is within the scope of the present invention.

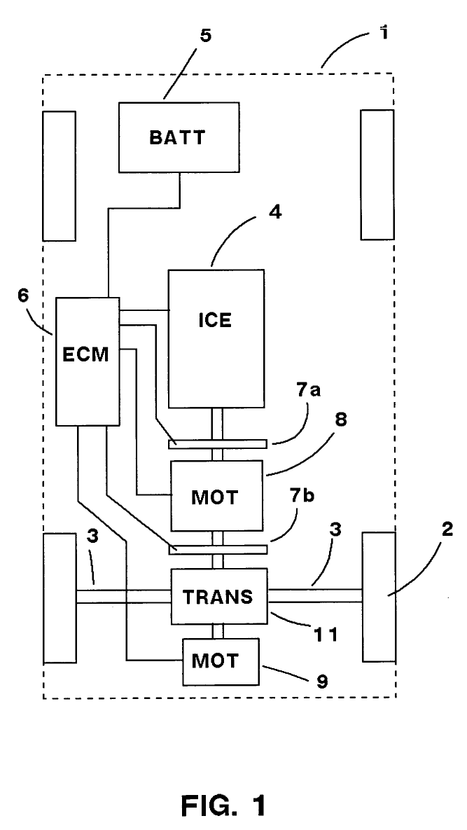

Turning to FIG. 1, an embodiment of a drive apparatus is seen. A vehicle 1 contains a battery 5 that is electrically connected to an electronic control module (ECM) 6. An internal combustion engine (ICE) 4 drives a first clutch 7a which in turn drives a first motor/generator 8. This first motor/generator 8 can be coupled through a second clutch 7b to a differential 11 that drives the wheels 2 through a pair of drive shafts 3.

In a first mode of operation, the ICE 4 can drive the first motor/generator 8 in a generator mode by closing clutch 7a. charging the battery 5. The second motor 9 can directly drive the differential 11 by taking current from the battery 5. In this mode, the vehicle can run as a classical serial hybrid. In this mode, the second motor/generator 9 can optionally recapture energy from braking by acting as a generator during breaking providing current to the battery 5. In another mode, the first motor/generator 8 can be disconnected form the ICE 4 by opening the first clutch 7a. This motor can then be coupled into the differential 11 through a second clutch 7b. In this mode, both motors can drive the wheels, and both motors in a generator mode can recapture energy from breaking.

In another mode, the second motor 9 drives the wheels (and optionally recaptures braking energy) while the first motor 8 simply floats and is not used. In this mode, the first motor 8 (which is not running) can be clutched to the ICE 4 if desired with the ICE not running. This is a very economical mode that can be used for straight electric service with optional battery recharging from wall current or other external source. Charging can also take place at a later time and/or place in this mode by simply starting the ICE 4 and coupling it to the first motor 8 in generator mode through the first clutch 7a. Generally however, line charging is more economical than charging with an ICE. If extra power is needed in this totally electric mode, the second motor/generator 8 can be coupled as a motor through the second clutch 7b directly to the differential 11 so that both electric motors can provide power to the wheels or output shaft.

When it is desired to start the ICE 4, the first motor/generator 8 can be coupled to the ICE 4 through the first clutch 7a and used in a motor mode to turn over the ICE. Once the ICE starts, the clutch 7a can either release the motor 8, or the motor 8 can be switched into a generator mode by the electronic control module 6 for battery charging.

The ECM 6 can contain high current DC or AC switching circuits known in the art to control the flow of high power current as well as control for the clutches and other components of the present invention. The ECM can also optionally contain a microprocessor running a stored control program. The ECM can be guided both from stored algorithms and from driver controls. The ECM can generally select any operating mode the vehicle is capable of running.

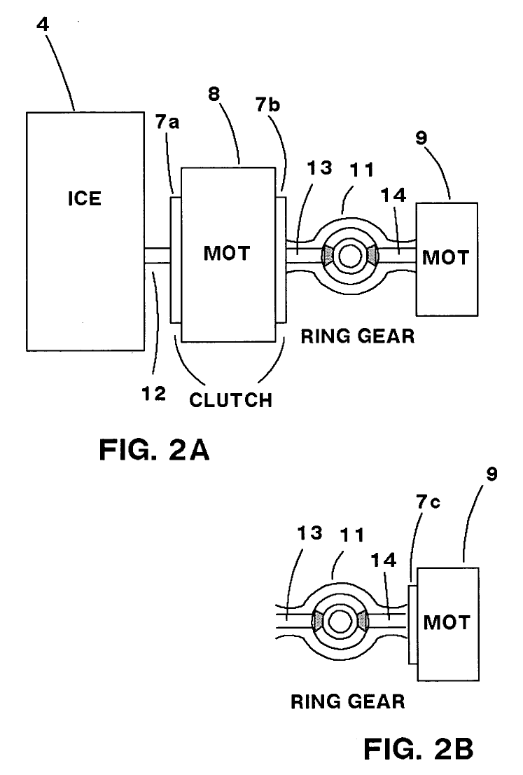

Turning to FIG. 2A, a diagram of the physical coupling of an ICE 4 and two motors to the clutches and the differential 11 can be seen. The ICE 4 can have a drive shaft 12 that runs into the first clutch 7a. This first clutch 7a is closely coupled mechanically to the first motor/generator 8. This motor/generator 8 is also closely coupled mechanically to the second clutch 7b which can be coupled by a shaft 13 into the differential 11. The second motor 9 is generally directly coupled, generally with no clutch into the differential 11 output shaft with a second shaft 14. It should be noted that an optional third clutch 7c may be used with the second motor 9. This is shown in FIG. 2B. While FIG. 2A shows the two motors as being of different sizes, this is not necessary. Any sizes of motors is within the scope of the present invention.

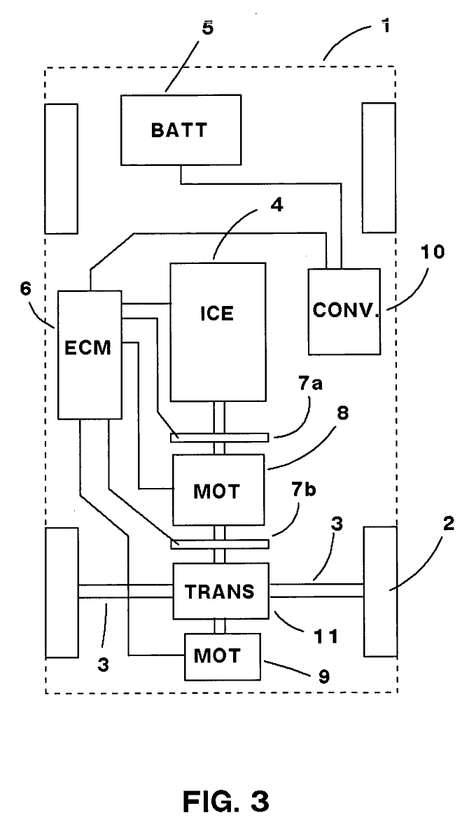

FIG. 3 shows the embodiment of FIG. 1 with the addition of a converter 10. This device can be used to change the voltage/current output from and to the motor/generators to the voltage/current required by the battery 5. This converter 10 is most effective when higher voltage motors are used with a lower voltage battery (such as a 12 volt battery). This converter 10 can also be used to provide the correct voltage for accessories which is usually 12 volts DC.

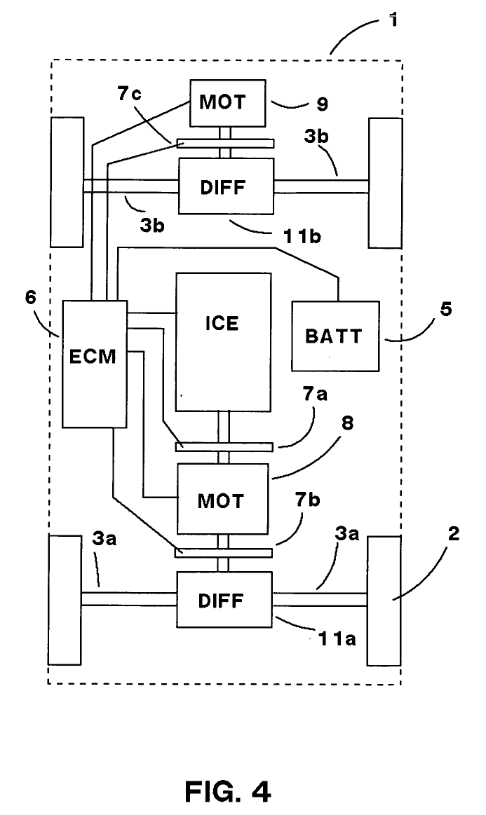

FIG. 4 shows an alternative embodiment where the second motor 9 is coupled through an optional clutch 7c to a second differential 11b on a second set of wheels, while a first differential 11a is coupled to the first set of wheels. In this embodiment, the second motor 9 provides the option of 4-wheel drive or alternate wheel drive if desired. It is also possible in still another embodiment to also attach the second motor 9 to the ICE through a fourth clutch to provide a wider choice of drive and charging options.

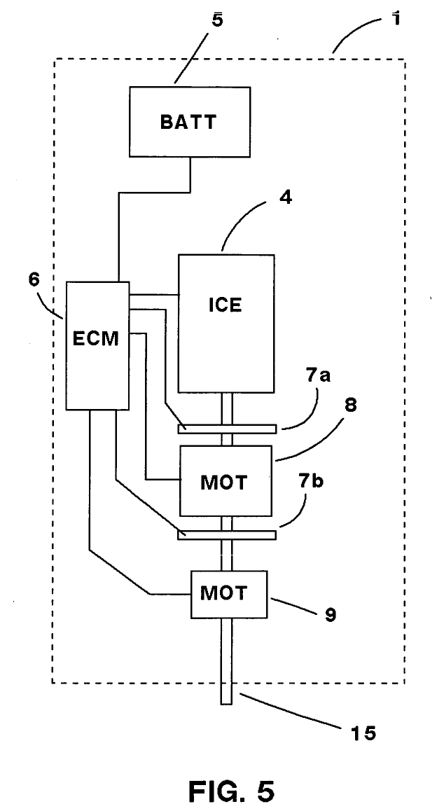

FIG. 5 shows the embodiment of FIG. 1 with no differential. This type of embodiment can be used for a direct drive shaft 15 such as might be used with a boat, aircraft or other craft.

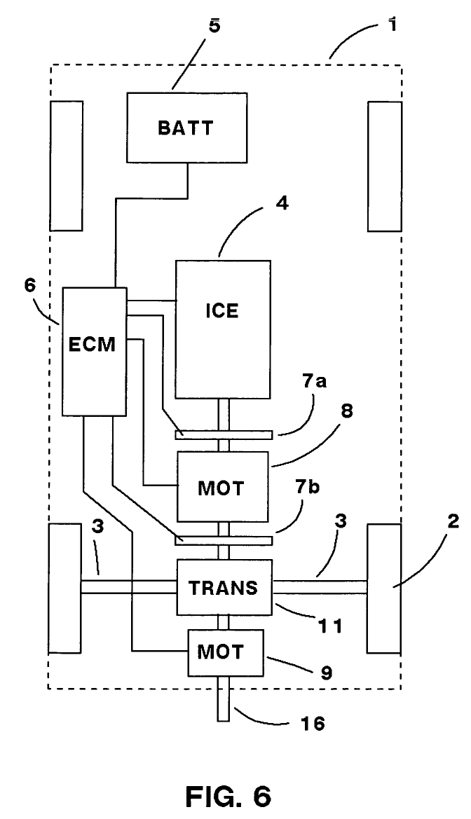

FIG. 6 shows the embodiment of FIG. 1 with a power take-off 16 from the second motor 9. This power take-off could be used to run accessories or itself coupled to the other set of wheels to provide 4-wheel drive or all-wheel drive.

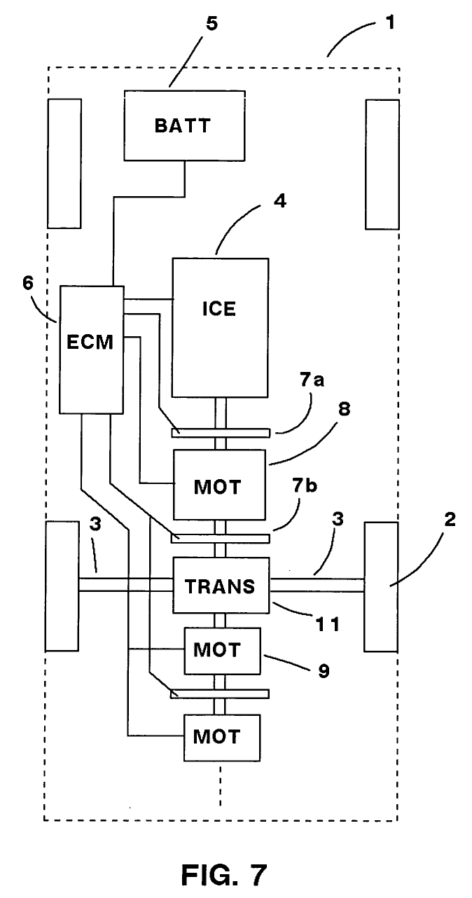

FIG. 7 shows that multiple tandem smaller electric motors can be clutched in when needed for more power and clutched out when speed is reached and the power requirements are less.

FIG. 1 shows an electronic control unit. Several prior art references describe such a unit including Morimoto et al. in US 2001/0037645 who describes a control unit that takes vehicle speed, battery voltage, accelerator, brake and other signals and uses a motor controller and motor driver to drive an electric motor and a clutch. U.S. Pat. No. 6,474,068 and U.S. Pat. No. 6,594,998 also describe controllers. US 2001/0037645, U.S. Pat. Nos. 6,474,068 and 6,594,998 are hereby incorporated by reference.

Several descriptions and illustrations have been provided to aid in understanding the present invention. One skilled in the art will realize that numerous changes and variations are possible without departing from the spirit of the invention. Each of these changes and variations is within the scope of the present invention.

I claim:

1. A hybrid vehicle drive apparatus comprising:
an internal combustion engine:
a first motor/generator coupled to said internal combustion engine through a first clutch;
a differential or direct drive shaft coupled to said first motor/generator through a second clutch;
a second motor/generator coupled to said differential.

2. The hybrid vehicle drive system of claim 1 further comprising an electronic control module controlling at least said first and second clutches.

3. The hybrid vehicle drive system of claim 2 wherein said electronic control module also controls said first and second motor/generators.

4. The hybrid vehicle drive system of claim 1 further comprising a battery electrically coupled to said first and second motor/generators.

5. The hybrid vehicle drive system of claim 4 wherein said second motor/generator can supply current to said battery during braking.

6. The hybrid vehicle drive system of claim 4 wherein said first motor/generator can supply current to said battery.

7. The hybrid vehicle drive system of claim 1 further comprising a direct drive take-off from said second motor.

8. A hybrid drive system comprising an internal combustion engine;
a first motor/generator mechanically coupled to said internal combustion engine through a first clutch;
a differential mechanically coupled to said first motor/generator through a second clutch;
a second motor/generator mechanically coupled to said differential;
a battery;
wherein, said battery is electrically coupled to said first and second motor/generators such that said first motor/generator can charge said battery and said second motor/generator can take current from said battery running as a motor.

9. The hybrid drive system of claim 8 wherein both said first and said second motor/generators can take current from said battery and run as motors.

10. The hybrid drive system of claim 8 further comprising an electronic control system controlling at least said first and second clutches.

11. The hybrid drive system of claim 10 wherein said electronic control system can control said first and second motor/generators.

12. A method for reducing rotating mass in a hybrid drive system comprising:
providing a first motor/generator capable of selectively being directly coupled to an internal combustion engine or directly to a differential or drive shaft;
providing a second motor/generator directly coupled to said differential or drive shaft.

13. The method of claim 12 further comprising providing a first clutch between said first motor/generator and said internal combustion engine and a second clutch between said first motor/generator and said differential or drive shaft.

14. The method of claim 13 further comprising providing an electronic control unit that controls said first and second clutches.

15. The method of claim 12 further comprising providing said second motor/generator with a power take-off shaft.

16. The method of claim 15 wherein said second motor drives a second differential or drive shaft through said power take-off shaft.

17. The method of claim 12 further comprising at least one additional motor coupled through a clutch to said second motor.
